(19) United States
(12) Patent Application Publication
(10) Pub. No.: US 2026/0114436 A1
(43) Pub. Date: Apr. 30, 2026

(54) Fishing Reel Adapter

(71) Applicant: 1498036 B.C. LTD, Courtenay (CA)

(72) Inventor: Lawrence Pattinson, Courtenay (CA)

(21) Appl. No.: 19/362,498

(22) Filed: Oct. 20, 2025

Related U.S. Application Data
(60) Provisional application No. 63/713,526, filed on Oct. 29, 2024.

(51) Int. Cl. A01K 89/017; B25F 3/00

(52) U.S. Cl. CPC A01K 89/017; B25F 3/00

(57) ABSTRACT

A device and method for fishing, in particular retrieving line on a fishing reel from great depths. In some implementations, the device may be an adapter connecting a drill to handles of the reel. The device may include a baseplate, a drive bit fixed to the center of the baseplate and retaining walls arranged to accommodate handles of a fishing reel. The retainer shape is designed to fit a given reel type with some implementations suitable for a variety or reel types and sizes. The device enables an angler to quickly retrieve a lure without purchasing an electric reel.

### FIELD OF THE INVENTION

The invention relates generally to fishing, in particular, devices and methods for reeling in fishing line on to a fishing reel.

### BACKGROUND OF THE INVENTION

In certain fishing scenarios, particularly deep-sea fishing, the fishing line may need to be lowered to significant depths, often reaching 300 feet or more. In such cases, there are various reasons a angler may need to retrieve the line: for example, to inspect or adjust the lure, check for tangling, or determine if the line has made contact with the seabed. Manually reeling in the line from such depths can be time-consuming and labor-intensive.

A common solution involves utilizing an electric motor integrated into the fishing reel, which enables rapid retrieval of the line. However, this approach presents several disadvantages: it requires the use of a specialized, often costly reel that is susceptible to damage. If damaged, the entire reel must typically be replaced. Additionally, the integrated electric system requires regular battery recharging, adding to maintenance complexity. These factors make the motorized reel option less practical and more expensive for many users.

### SUMMARY OF THE INVENTION

To address the shortcomings of the current devices, a new device is provided that has these advantages and solves certain problems mentioned above.

In accordance with a first aspect of the invention there is provided a device to connect a drill to a fishing reel. The device may include a baseplate, a drive bit fixed to the center of the baseplate on a first side and extending away therefrom. The device may furthermore include retaining structure connected to and extending away from an opposing side of the baseplate and arranged to accommodate two spaced-apart handles of a fishing reel.

Implementations may include one or more of the following features. Device where the drive bit may include a hollow plastic shank with metal bit inserted therein. Device where the retaining structure may include thin walls shaped and sized to accommodate the handles. Device where the retaining structure is shaped as two hollow cylinders, axially extending from the baseplate. Device where the retaining structure may include walls defining a pair of spaced-apart slots, each slot having a recess arranged to accommodate one of said handles. Device where the retaining structure may include two U-shaped portions, each portion having walls extending from ends of the baseplate and being open towards a middle of the baseplate. Device where the retaining structure may include two opposing channels, each extending from an outer edge of the base plate towards the center of the baseplate, but not extending across the center. Device where the retaining structures may include portions arranged to let the handles break-away under high loads. Device where the drive bit is hexagonal.

In accordance with a second aspect of the invention there is provided a method of operating a fishing rod using the device of claim 1 comprising: lowering a lure on a fishing line to a desired depth; connecting to handles of a reel of the fishing rod to the retaining structure of the device; connecting a chuck of an electric drill to the drive bit of the device; and operating the electric drill in order to wind the fishing line onto the reel.

Further aspects of the invention are set out below and in the appended claims. Thus preferred embodiments of the invention enable the device to retrieve fishing line at much higher speeds than can be achieved by hand, without needing to purchase a electric reel with integrated motor.

### BRIEF DESCRIPTION OF THE DRAWINGS

Various objects, features and advantages of the invention will be apparent from the following description of embodiments of the invention, as illustrated in the accompanying drawings. The drawings are not necessarily to scale, emphasis instead being placed upon illustrating the principles of various embodiments of the invention.

FIG. 1A is a plan view of a fishing reel adapter.

FIG. 1B is a side view of the adapter in FIG. 1A.

FIG. 1C is an end view of the adapter in FIG. 1A.

FIG. 1D is a perspective view of the adapter in FIG. 1A.

FIG. 2 is an assembly view of the end of the adapter.

FIG. 3A is a plan view of a fishing reel adapter in a U-shape embodiment.

FIG. 3B is a side view of the adapter in FIG. 3A.

FIG. 3C is a perspective view of the adapter in FIG. 3A.

FIG. 4 is a perspective view of a fishing reel adapter in an elongate slot embodiment.

FIG. 5 is a perspective view of the adapter connected to a fishing reel and drill.

FIG. 6A is a front view of a fishing reel.

FIG. 6B is an end view of a fishing reel.

Similar reference numerals indicate similar components having the following key:
1 Adaptor
5 Baseplate
7 Drive bit
8, 48, 38 Retaining structures
9 Drive bit holder
11 Spool
12 Reel foot
15 Fishing reel
16 Handles
17 Drag adjustment knob
18 Reel frame
19 Arbor
20 Drill
25 Drill chuck
27 Drive insert

### DETAILED DESCRIPTION OF THE INVENTION

With reference to the accompanying figures, devices and methods are disclosed for operating a fishing reel, in particular driving the fishing reel with a motorized adapter external to the fishing reel. In preferred embodiments, the device provides an adapter that connects an electric drill to the fishing reel. The adapter has a base plate with a central drive bit extending from a rear of the base plate and retaining structures extending from the front of the base plate. The bit is designed to fit into the chuck of an electric drill. The retaining structures are sized to surround and drive the two handles of the fishing reel, in order to reel in the fishing line at high speed, typically at very low loads.

In operation, the angler connects the adapter's bit to the chuck of a power drill, for later use. During deep-sea fishing, a lure is typically deployed to the seabed, often using a downrigger. When an issue is suspected with the lure or the fishing setup, the angler needs to retrieve the entire line for inspection. At this point, the angler mounts the adapter's retaining structure around the reel handles and activates the drill in the appropriate direction to reel in the line. Most fishing reels feature a ratchet mechanism that permits the reel to wind in line in only one direction. Many drills have a torque limited clutch that disengages the chuck from rotation when the drive torque exceeds the user-settable threshold. The angler can set a suitably low torque setting that will reel in an unladen lure and line, and disengage if a fish strikes the lure during retrieval. As long as the adapter 1 securely engages reel handles 16, the drill 20 will retrieve the entire line within a few minutes. During this process, the fishing rod can either be placed in a rod holder or held with one hand while the other hand operates the drill.

Dimensions of the adaptor relate to the reel for which it is designed. The baseplate's purpose is to provide a support connection for the retaining structure's walls and drive bit 7, while keeping them in the correct relative spacing. The baseplate 5 could be any shape to accomplish this, and in the simplest example shown in the figures the baseplate is generally shaped as a thin rectangular plate that is substantially as long as the distance between outer edges of the handles. The width of the plate is substantially as wide as the reel's handles plus the retaining wall thickness. The drive bit is located at the center of the baseplate, typically concentric with the drag adjustment knob 17, when the adapter is mounted. The skilled person will appreciate that the baseplate could also be a disc, having a similar diameter as the spool's diameter.

The retaining structure' wall extends away from the frontside of the baseplate 5. The depth of the retaining structure 8 (defined by the wall's extension distance) may be substantially the same, preferably being slightly less than the height of the handles. This prevents the baseplate from rubbing against the drag adjustment knob that typically protrudes beyond the spool's face. The depth of the retaining structure may be 1-3 cms.

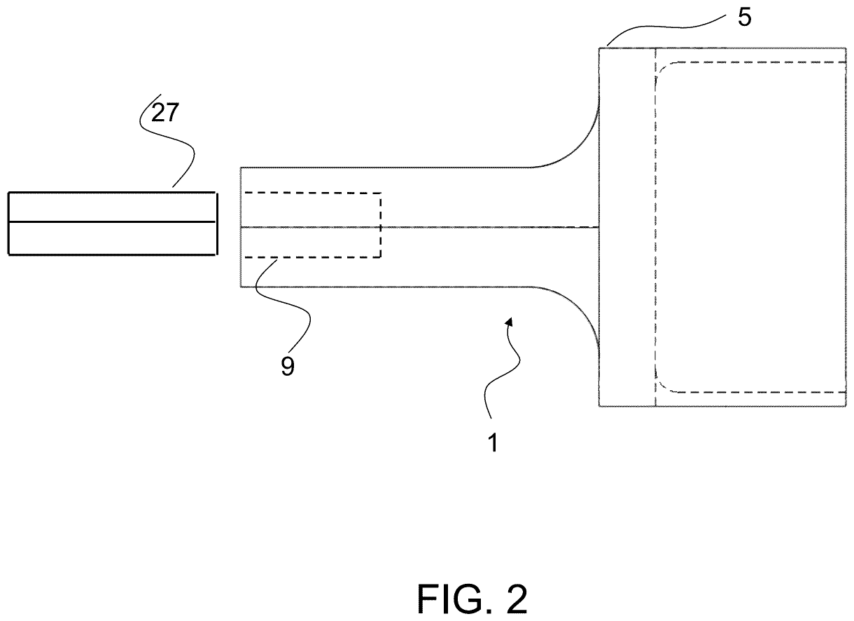

In the embodiment of FIG. 2, the rear side of the base comprises drive shank 9 with a hollow center to accept a metal drive insert 27 to act as the drive bit for the drill. This arrangement keeps the cost low by using cheaper material for most of the adapter and a metal insert with torsional strength where needed. Alternatively the drive bit is a solid plastic protrusion, integral with the baseplate, and designed to be held by drill chuck 25. The metal or plastic drive bit 7 may have a circular or hexagonal shank (in cross-section), with a diameter approximately ½″ or ⅜″ for standard chucks. The drive bit may have recess in the shank near the distal end of the bit to engage with the quick-release ball of the drill.

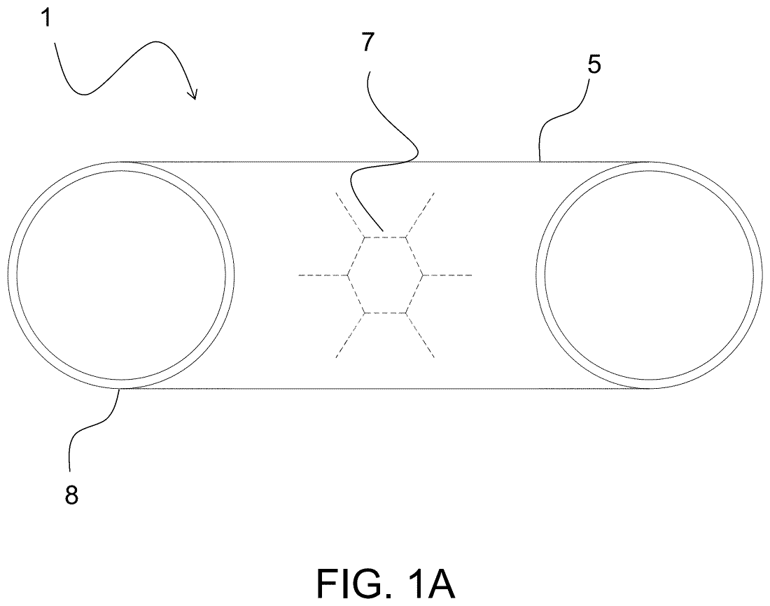

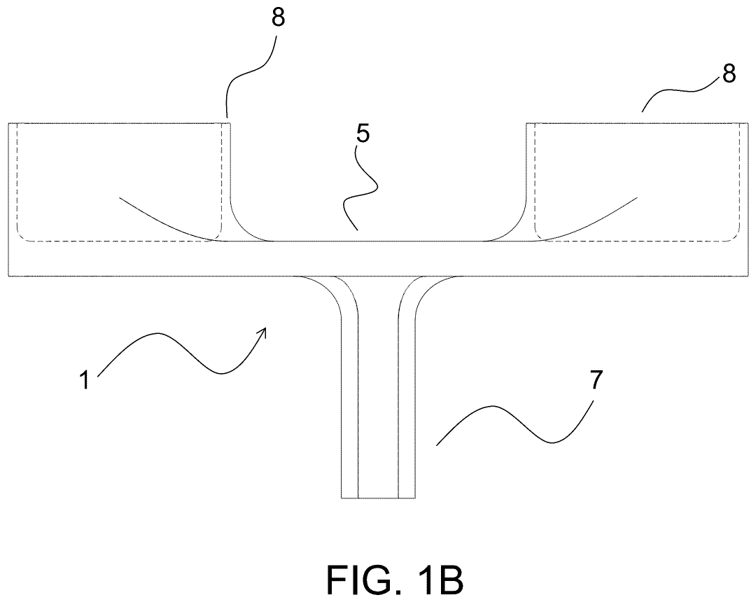

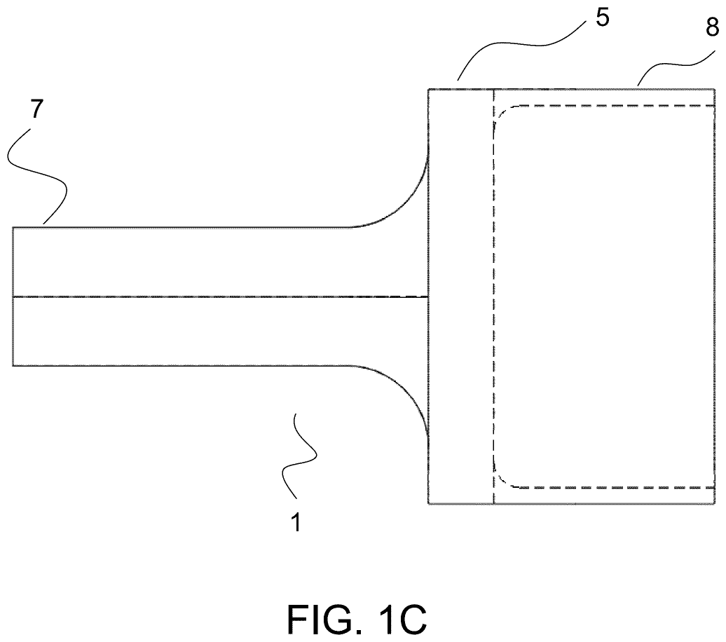

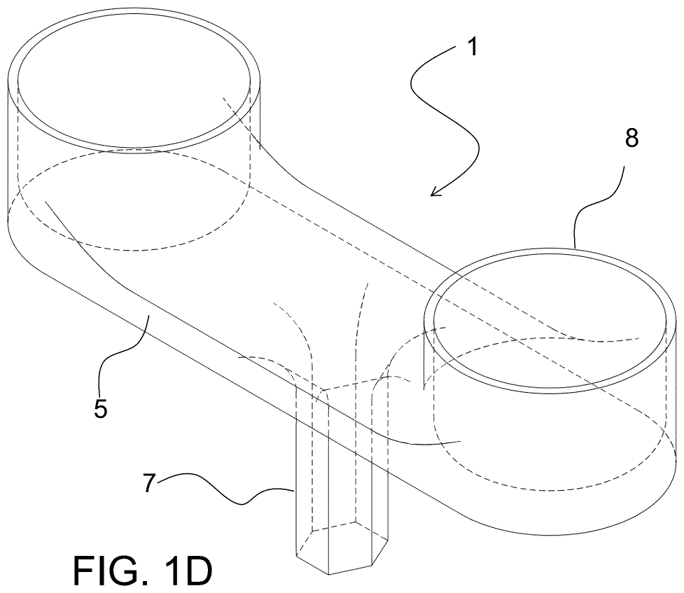

Referring to FIGS. 1A, 1B, 1C, 1D, the retaining structures 8 are designed as cylindrical walls with a hollow or recessed interior, configured to enclose around the reel handles. These handles 16 are typically positioned diametrically opposite each other on the reel spool 11, usually spaced 8-12 centimeters apart, with a central drag adjustment knob 17 protruding from the midpoint of the reel. In this embodiment, the cylindrical retaining walls 8 enclose the handles, without any material between opposing cylinders in order to avoid contact with the drag adjustment knob. As an example, the retaining cylinders may be positioned 10 centimeters apart (i.e. center to center), with each cylinder hollow having a diameter of 2-3 centimeters and a wall thickness of approximately 3 to 5 millimeters. It will be understood by those skilled in the art that the distance between the retaining cylinders and their dimensions can vary depending on the size of the reel being used, as reels come in a range of sizes. The depth of the cylinders, typically between 1 and 3 centimeters, is sufficient to enclose the height of the handle and securely retain it. The advantage of this configuration is that the handles are snugly retained, reducing the likelihood of slippage during the rotation of the adapter.

The embodiment depicted in FIG. 2 is compatible with reels of different sizes. Here, the retaining walls form two elongated slots, spaced-apart along the major axis of the base plate, i.e. set apart radially when mounted on the reel. This design allows the retaining slots to engage handles of various sizes and spacing. The width of the slot, corresponds approximately to the diameter of the handles, ensuring a secure fit. The length of the slot is wider than the width in order to accommodate reels of different sizes, in which their handles are further apart. This allows the adapter to remain snugly engaged while accommodating different reel sizes.

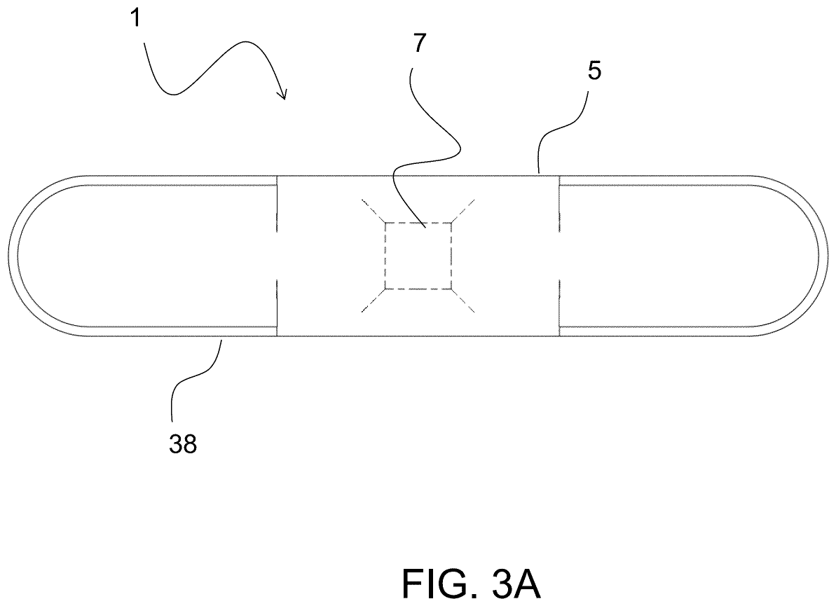

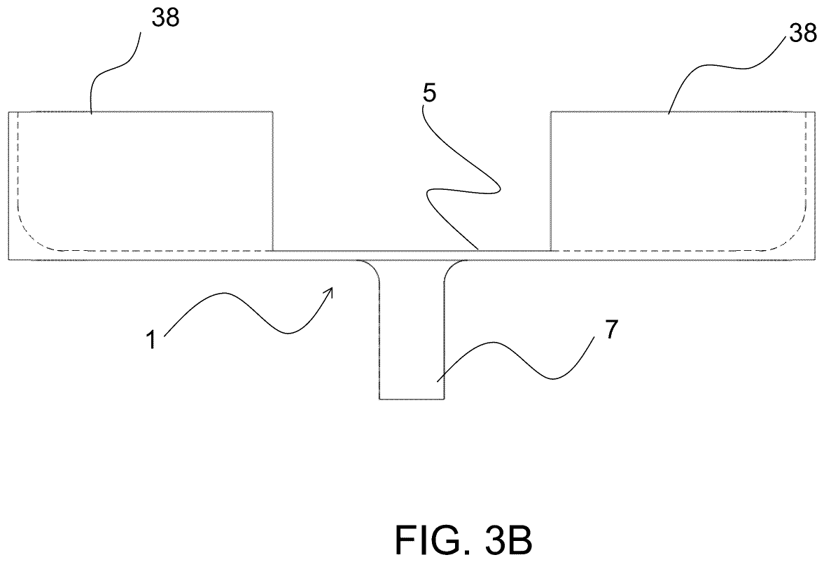

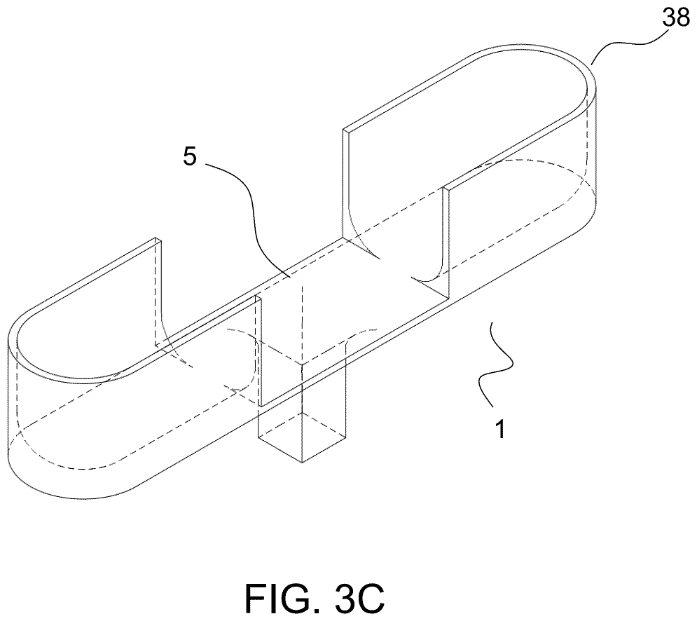

In the embodiment shown in FIG. 3, a single slot is defined by the retaining walls. This embodiment is similar to FIG. 2 but features walls extending the entire length of the base plate to retain both handles within a single slot. The walls may be adapted to accommodate the central drag knob, either by providing a space in the middle of the slot wide enough to enclose the drag knob, or by removing portions of the wall near the center of the reel when mounted. This design offers a stronger overall structure for driving the handles but does not allow access to the drag knob during operation.

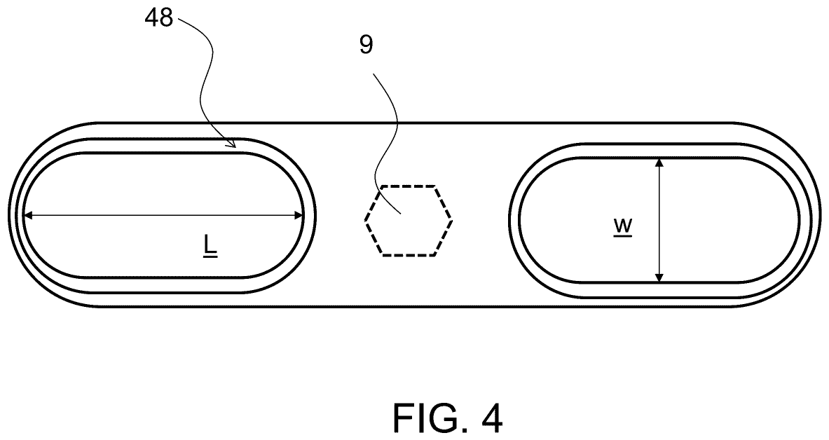

The embodiment described in FIG. 4 is the most flexible. In this configuration, two walls engage the handles only when rotating in one direction. Unlike previous designs, this version does not fully enclose the handles, which allows for rotation in a single reeling direction without complete retention. While the cylindrical configuration of Version 1 provides a more secure hold on the handles, Version 4 is less snug but offers the highest adaptability across various reel sizes.

In some embodiments, the retaining structure may be designed to bend or disengage at high-loads to auto-release the handles from being driven too hard. This may be achieved by providing a break-away feature at a portion of the wall near the location contacting the handles, such as a) a vertical slot in the wall (i.e. in the direction that the wall extends from the base), b) the wall not being connected to the base, c) the walls being thinner than the remaining wall, d) a frangible portion of the wall. In this way, a fish suddenly attaching to a lure that is being retrieved will add a sudden high-load, which might otherwise snap off the drive bit or retaining structure. Instead, the walls ‘break-away’ to release the reel's handles and save the adapter.

The adapter may be formed by any rigid material, for example metal, wood or plastic. Plastic is the cheapest for manufacture with more flexibility of design features. The adapter is preferably a single piece construction. The adapter may be injection molded or 3D printed. Fillets are preferably designed at locations of stress concentration, for example locations of loading or where protrusions contact the base. As best seen in FIG. 1B, a) drive bit 7 integrally formed with base 5 and with retaining structure 8, includes fillets for increased strength at the location of the stress concentration where the parts meet.

### Fishing Reel Components

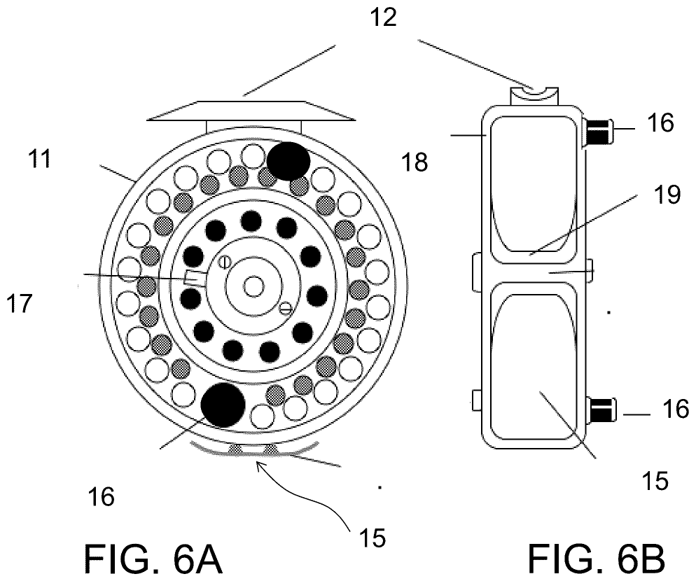

The adapter is intended for driving certain types of fishing reel, exemplified by FIG. 6. A frame 18 forms the body of the reel, providing structural support and housing various internal components. Made from materials such as aluminum, graphite, or composite alloys, the frame is designed to be lightweight yet strong enough to withstand the forces encountered during fishing. The frame typically includes a foot 12 for mounting the reel onto the fishing rod.

The arbor 19 is the central cylinder around which the fishing line is wound. In an arbor reel, the arbor is larger in diameter compared to traditional reels, allowing for faster line retrieval and reduced line memory (the tendency of the line to retain coils).

The spool 11 is the rotating part of the reel that holds the fishing line. It is mounted on the arbor and can be removed or replaced for maintenance or to change line types. The spool typically features ventilation holes or cutouts to reduce weight and improve airflow for drying wet lines, preventing corrosion. The capacity of the spool is determined by the diameter and width of the arbor.

The drag system controls the tension applied to the line during a fish's run, allowing the angler to exert controlled pressure on the fish without breaking the line. There are two primary types of drag systems in arbor reels: disc drag and click-and-pawl drag. The drag adjustment knob 17 is usually located on the exterior of the reel, allowing for real-time tension adjustments during fishing.

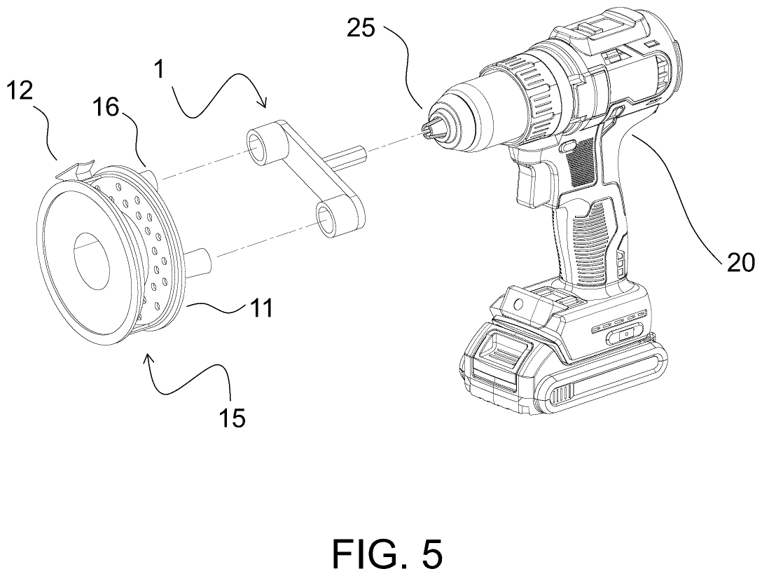

Two handles 16 are attached to the spool and are used to manually retrieve the line. Made from metal or durable plastic, the handles can feature ergonomic grips to improve user comfort. Some reels may have reversible handles, allowing both left- and right-hand use. As shown in FIG. 5, two handles are located diametrically opposite each other.

The reel foot 12 is a part of the frame that attaches the reel to the fishing rod. It is secured to the rod via reel seat clamps, ensuring a stable connection. The foot is typically made from a strong yet lightweight material to maintain balance and durability.

A drag adjustment knob 17 allows the angler to fine-tune the drag system by increasing or decreasing friction on the spool. In disc drag systems, this knob adjusts the pressure applied by the drag washers. It is usually located in the middle of the disc having the handles. In some versions, the knob is proud of the spool's plane, in which case the adapter is designed with the retaining wall not crossing the center of the baseplate on the front side.

A one-way ratchet mechanism prevents backward rotation of the spool. This is useful for maintaining tension on the line during the retrieval process and is often integrated into the drag or bearing system.

The skilled person will appreciate that the size and shape of certain parts depend on the size and shape of external components, such as reel handles, drag release knobs, and drill chucks with which they are intended to cooperate. As used herein, parts described as adapted, designed, configured, or arranged for a stated purpose are to be understood as having the appropriate dimensions, structure, and material characteristics for that purpose and cooperating with the appropriate external component.

Terms such as “top”, “bottom”, “distal”, “proximate,” “below,” “above,” “upper, are used herein for simplicity in describing relative positioning of elements of the reel or device, as depicted in the drawings. Although the present invention has been described and illustrated with respect to preferred embodiments and preferred uses thereof, it is not to be so limited since modifications and changes can be made therein which are within the full, intended scope of the invention as understood by those skilled in the art.

1. A device for fishing comprising
a baseplate
a drive bit fixed to the center of the baseplate on a first side and extending away therefrom,
retaining structure connected to and extending away from a second side of the baseplate opposing the first side, and arranged to accommodate two spaced-apart handles of a fishing reel.

2. The device of claim 1, wherein the drive bit comprises a hollow plastic shank with metal bit inserted therein.

3. The device of claim 1, wherein the retaining structure comprises thin walls shaped and sized to accommodate the handles.

4. The device of claim 1, wherein the retaining structure is shaped as two hollow cylinders, axially extending from the baseplate.

5. The device of claim 1, wherein the retaining structure comprises walls defining a pair of spaced-apart slots, each slot having a recess arranged to accommodate one of said handles.

6. The device of claim 1, wherein the retaining structure comprises two U-shaped portions, each portion having walls extending from ends of the baseplate and being open towards a middle of the baseplate.

7. The device of claim 1, wherein the retaining structure comprises two opposing channels, each extending from an outer edge of the base plate towards the center of the baseplate, but not extending across the center.

8. The device of claim 1, wherein the retaining structures comprise portions arranged to let the handles break-away under high loads.

9. The device of claim 1, further comprising a fillet where the drive bit extends from the baseplate.

10. The device of claim 1, wherein the retaining structures do not extend across a center portion of the baseplate.

11. The device of claim 1, wherein the drive bit is hexagonal.

12. A method of operating a fishing rod using the device of claim 1 comprising:
a. lowering a lure on a fishing line to a desired depth;
b. connecting to handles of a reel of the fishing rod to the retaining structure of the device;
c. connecting a chuck of an electric drill to the drive bit of the device; and
d. operating the electric drill in order to wind the fishing line onto the reel.
